(19) United States
(12) Patent Application Publication
(10) Pub. No.: US 2011/0188966 A1
(43) Pub. Date: Aug. 4, 2011

(54) FASTENING SCREW BOLT

(76) Inventor: Ching-Cheng TSAI, Kaohsiung County (TW)

(21) Appl. No.: 12/836,629

(22) Filed: Jul. 15, 2010

(30) Foreign Application Priority Data
Jan. 29, 2010 (TW) 099102616

(51) Int. Cl. F16B 35/04

(52) U.S. Cl. 411/412; 411/423

(57) ABSTRACT

A fastening screw bolt includes a head connected to a screw rod. The screw rod includes a helical thread having a plurality of helical turns each of which turns one revolution around the screw rod. Each helical turn has a helical cutting edge formed with at least two angularly spaced apart notches. With the notches, the screw bolt can achieve an improved engagement with a hole into which the screw bolt is inserted.

### CROSS-REFERENCE TO RELATED APPLICATION

This application claims priority to Taiwanese Application No. 099102616, filed on Jan. 29, 2010.

### BACKGROUND OF THE INVENTION

1. Field of the Invention

The invention relates to a screw, more particularly to a fastening screw bolt.

2. Description of the Related Art

FIG. 1 illustrates an expansion screw 1 that includes a nut 12, a screw rod 11 and a retaining sleeve 13. The retaining sleeve 13 includes a housing 131 connected to an expansion part 132 and confining a through hole 133. The screw rod 11 includes a rod body 111 that extends through the through hole 133 and that has a threaded portion 112 and a cone portion 113. In order to use the expansion screw 1, a mounting hole is first drilled in a concrete wall (not shown), and the expansion screw 1 is inserted into the mounting hole along a direction shown by an arrow in FIG. 1. When the nut 12 is tightened, the nut abuts against the top end of the retaining sleeve 13, and the cone portion 113 is pulled into the expansion part 132, thereby expanding the expansion part 132 and anchoring the expansion screw 1 in the mounting hole. Thus, a work piece can be secured to a concrete wall using the retaining sleeve 13, the screw rod 11 and the nut 12.

However, because the expansion screw 1 is anchored in the mounting hole by the expansion part 132 and the cone portion 113, it is difficult to detach the expansion screw 1 from the concrete wall. In addition, the construction of the expansion screw 1 is complicated, and the manufacturing cost thereof is relatively high because the screw rod 11, the nut 12 and the retaining sleeve 13 have to be fabricated individually and then assembled together. Therefore, it is highly desirable to provide a screw that can be secured firmly to a structure or support and that can be detached therefrom easily.

### SUMMARY OF THE INVENTION

An object of the present invention is to provide a simple fastening screw bolt that can be secured firmly to a concrete structure, such as a concrete wall or floor, and that can be detached easily therefrom.

Accordingly, a fastening screw bolt of this invention comprises a head, and a screw rod connected to the head. The said screw rod includes a first section proximate to the head, a second section extending from the first section in a direction away from the head, and a first helical thread that is formed around the first and second sections and that has a plurality of helical turns each of which turns one revolution around the screw rod. Each of said helical turns has a helical cutting edge formed with at least two angularly spaced apart notches. The second section has a hardness higher than that of the first section. The first section and the head have a corrosion resistance higher than that of the second section. Each of the first and second sections is made of a material selected from the group consisting of alloyed steels, high carbon steels, martensite steels, and austenite steels.

### BRIEF DESCRIPTION OF THE DRAWINGS

Other features and advantages of the present invention will become apparent in the following detailed description of the preferred embodiments with reference to the accompanying drawings, of which:

FIG. 1 is a side sectional view of a conventional expansion screw;

FIG. 2 is a perspective view of the first preferred embodiment of a fastening screw bolt according to the present invention;

FIG. 3 is a top sectional view of the first preferred embodiment;

FIG. 4 is a side sectional view of the first preferred embodiment at a use state;

FIG. 5 is a perspective view of the second preferred embodiment of the fastening screw bolt according to the present invention;

FIG. 6 is a side sectional view of the third preferred embodiment of the fastening screw bolt according to the present invention;

FIG. 7 is a top sectional view showing a modified configuration of the notches formed in the fastening screw bolt according to the present invention;

FIG. 8 is a top sectional view showing another modified configuration of the notches formed in the fastening screw bolt according to the present invention;

FIG. 9 is a top sectional view showing a further modified configuration of the notches formed in the fastening screw bolt according to the pre sent invention; and

FIG. 10 is a top sectional view showing a still further modified configuration of the notches formed in the fastening screw bolt according to the present invention.

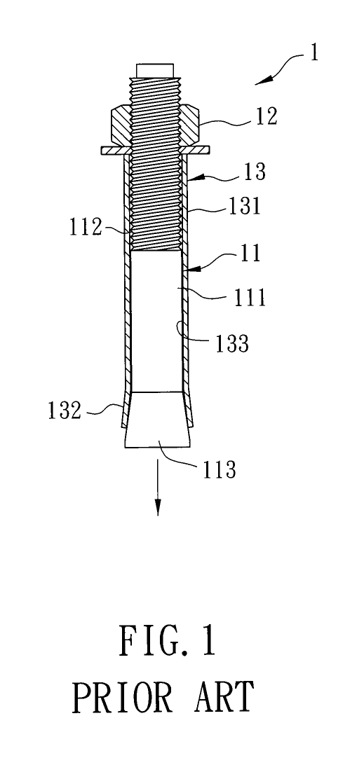

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

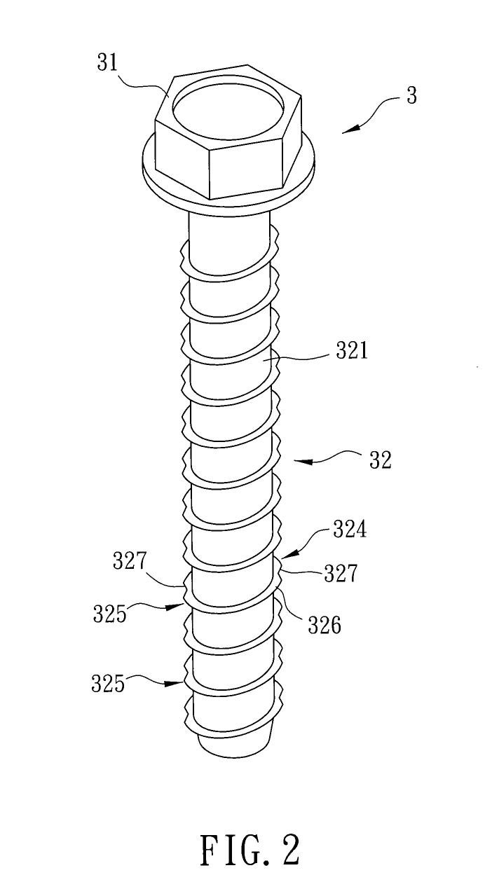

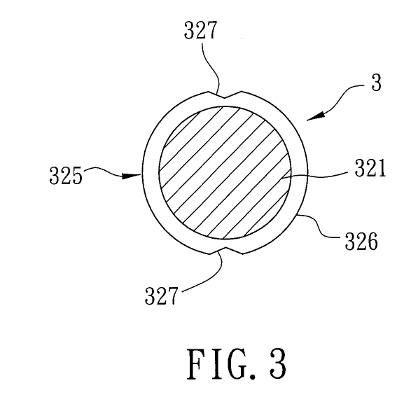

Referring to FIGS. 2 and 3, there is shown a fastening screw bolt 3 according to the first preferred embodiment of the present invention which includes a head 31 and a screw rod 32. The screw rod 32 has a rod body 321 connected to the head 31, and a first helical thread 324 that is formed helically around the rod body 321 and that has a plurality of helical turns 325 each of which turns one revolution around the rod body 321. Each of the helical turns 325 has a helical cutting edge 326 formed with two angularly spaced apart notches 327. The screw rod 32 and the head 31 are integrally formed and may be made from stainless steel, other alloyed steel, or other suitable metallic material.

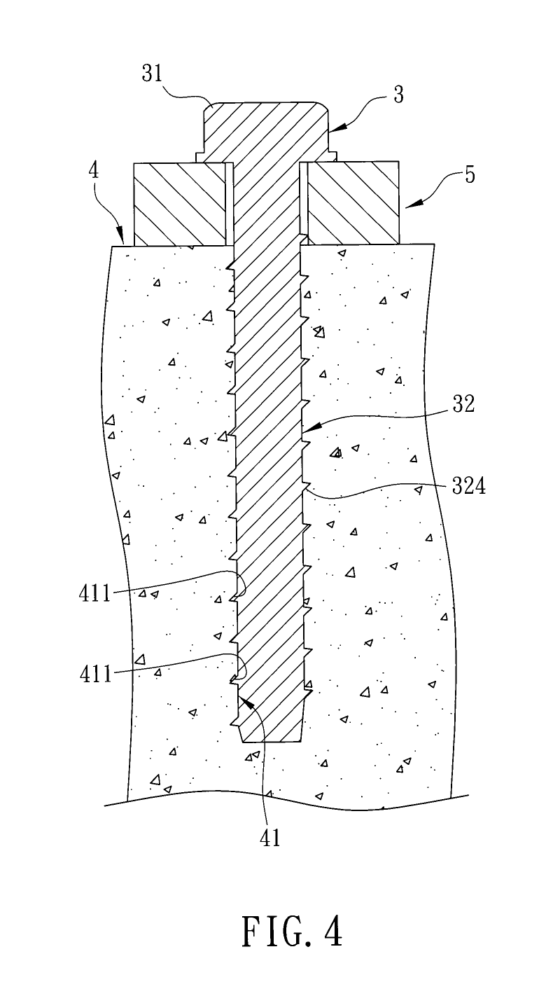

Referring to FIG. 4, the fastening screw bolt 3 is passed through a work piece 5 and is inserted into a hole 41 formed in a concrete wall 4 by rotating the fastening screw bolt 3 in a clockwise direction. During the rotation of the fastening screw bolt 3, the notches 327 (shown in FIG. 3) of the helical turns 325 cut into the inner surface of the hole 41 producing cut traces 411 in the inner surface. Because the screw rod 32 is engaged with the cut traces 411, the work piece 5 can be secured firmly to the concrete wall 4. While the screw bolt 3 is used in the concrete wall 4 in this embodiment, it can also be used in a wooden plate, a steel plate, etc.

Compared to the conventional expansion screw, the fastening screw bolt of the present invention has a relatively simple construction which can be attached conveniently to a concrete structure, such as a concrete wall, or floor. Moreover, the screw bolt 3 can be detached easily from the concrete wall by rotating it in a counterclockwise direction. In addition, the screw bolt 3 can provide a fastening effect as strong as that achieved by the conventional expansion screw.

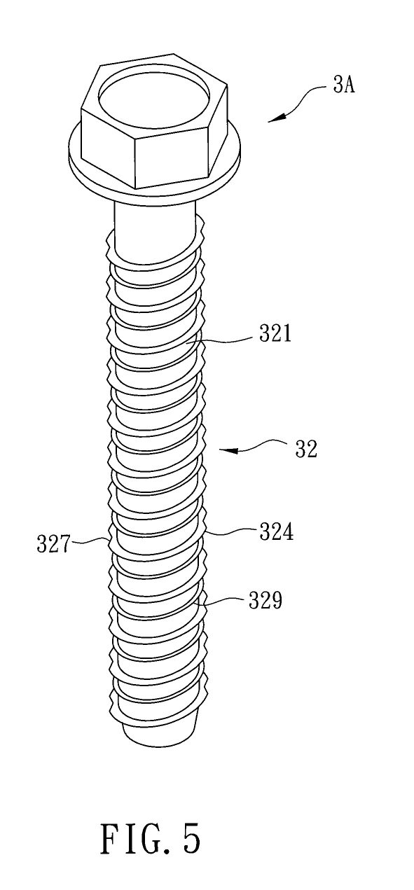

Referring to FIG. 5, there is shown a screw bolt 3A according to the second preferred embodiment of this invention, which differs from the first embodiment in that the screw rod 32 further includes a second helical thread 329 that extends helically between the helical turns 325 of the first helical thread 324. The second helical thread 329 has a height smaller than that of the first helical thread 324. With the second helical thread 329, the screw bolt 3A can provide an enhanced engagement with the hole 41 (FIG. 4) in the concrete wall.

While the second helical thread 329 as shown is not provided with any notch, the notches 327 formed in the first helical thread 324 can also be provided in the second helical thread 329 to increase the cutting effect of the screw bolt 3A.

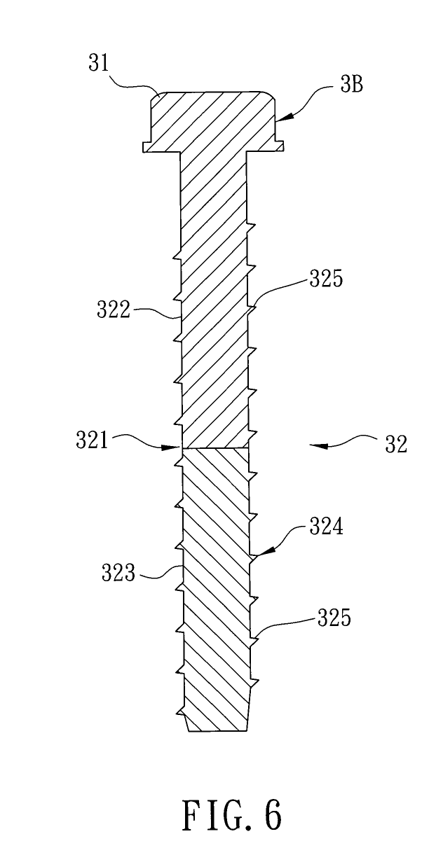

Referring to FIG. 6, the screw bolt 3B according to the third preferred embodiment of this invention differs from the first preferred embodiment in that the screw rod 32 includes a first section 322 adjacent to the head 31, and a second section 323 extending from the first section 322 in a direction away from the head 31. The second section 323 has a hardness higher than that of the first section 322, and the first section 322 has a corrosion resistance higher than that of the second section 323.

Preferably, the first section 322 and the head 31 are made of an austenite steel which can provide the first section 322 and the head 31 with a rustproof effect, and the second section 323 is made of an alloyed steel that can provide the second section 323 with a relatively high hardness. Of course, the first section 322 and the head 31 may also be made from an alloyed steel or a high carbon steel, and the second section 323 may also be made from a high carbon steel and a martensite steel. On the other hand, the head 31, the first section 322 and the second section 323 may be made from any suitable materials as long as they can provide the head 31 and the first section with good corrosion resistance and provide the second section 323 with an increased hardness.

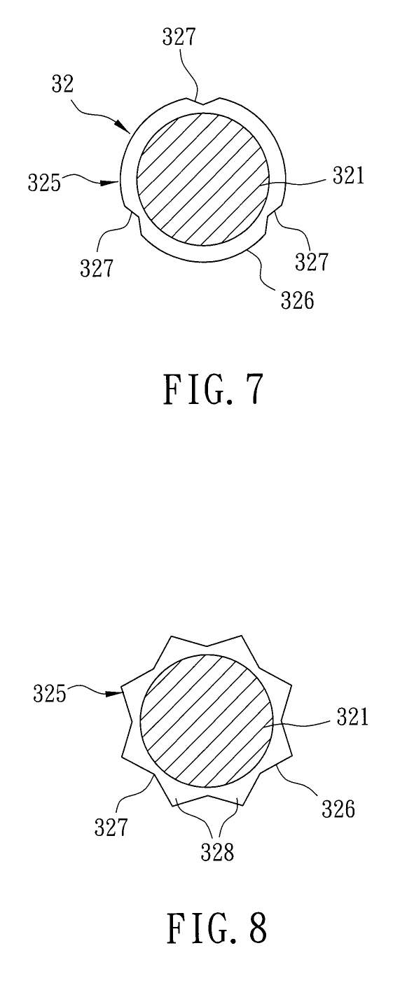

FIGS. 7-10 illustrate various modified configurations of the notches 327 formed in the helical cutting edge 326 of each helical turn 325. Referring to FIG. 7, the helical cutting edge 326 of each helical turn 325 has three notches 327 that are spaced apart angularly and equally from one another.

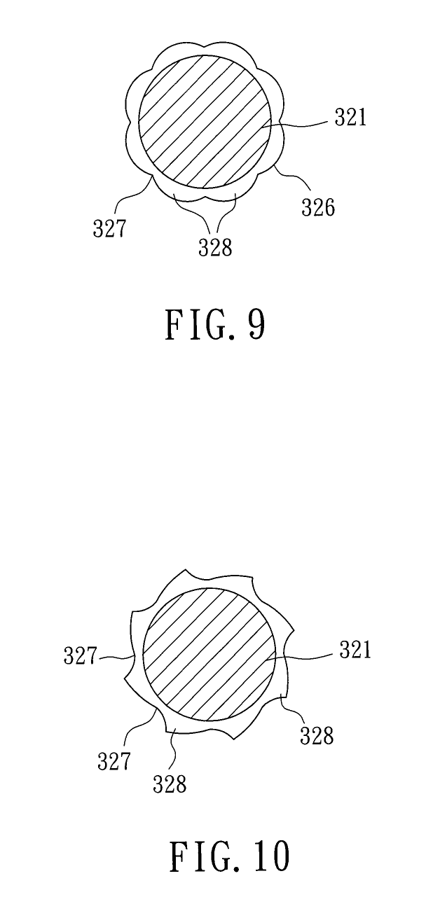

As shown in FIG. 8, the helical cutting edge 326 of each of the helical turns 325 has eight notches 327 that are spaced apart angularly and equally from one another and that are substantially V-shaped. Accordingly, there are multiple teeth 328, each formed between two notches 327 and each having a substantially V-shaped edge. Alternatively, each of the teeth 328 may have a rounded edge as shown in FIG. 9. Referring to FIG. 10, the teeth 328 are formed as inclined ratchet teeth.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A fastening screw bolt comprising:
a head, and a screw rod connected to said head;
said screw rod including a first section proximate to said head, a second section extending from said first section in a direction away from said head, and a first helical thread that is formed around said first and second sections and that has a plurality of helical turns each of which turns one revolution around said screw rod, each of said helical turns having a helical cutting edge formed with at least two angularly spaced apart notches;
said second section having a hardness higher than that of said first section, said first section and said head having a corrosion resistance higher than that of said second section;
each of said first and second sections being made of a material selected from the group consisting of alloyed steels, high carbon steels, martensite steels, and austenite steels.

2. The fastening screw bolt of claim 1, wherein said screw rod further includes a second helical thread that extends helically between said helical turns of said first helical thread, said first and second helical threads having different heights.

3. The fastening screw bolt of claim 1, wherein said helical cutting edge of each of said helical turns has three of said notches that are spaced apart angularly and equally from one another.

4. The fastening screw bolt of claim 1, wherein said helical cutting edge of each of said helical turns has a plurality of said notches which are spaced apart angularly and equally from one another, and a plurality of teeth, each of which is formed between two of said notches.

5. The fastening screw bolt of claim 4, wherein each of said teeth has a V-shaped edge.

6. The fastening screw bolt of claim 4, wherein each of said teeth has a rounded edge.

7. The fastening screw bolt of claim 4, wherein said teeth are formed as inclined ratchet teeth.
